(19) United States
(12) Patent Application Publication
(10) Pub. No.: US 2026/0119663 A1
(43) Pub. Date: Apr. 30, 2026

(54) AUTONOMOUS THREAT INVESTIGATION

(71) Applicant: Microsoft Technology Licensing, LLC, Redmond, WA (US)

(72) Inventors: Amir Hossein ABDI, Vancouver (CA); Anush SANKARAN, Burnaby (CA); Tong WANG, Montreal (CA); Michael Charles ALBADA, Seattle, WA (US)

(21) Appl. No.: 18/932,770

(22) Filed: Oct. 31, 2024

(51) Int. Cl. G06F 21/56

(52) U.S. Cl. CPC G06F 21/566; G06F 2221/034

(57) ABSTRACT

A threat investigation agent performs investigative operations for autonomously investigating a potential cyber security threat. The investigative operations include preparing and transmitting inputs to a language model that include at least known threat event information pertaining to the potential cyber security threat, a function list describing functions that execute different types of investigative operation, and instructions directing a language model to return an output identifying a next investigative action that the language model selects as appropriate based on the known threat event information and the function list. The threat investigation agent discovers additional threat event information by executing the next investigative action in response to receiving the output from the language model, updating the known threat event information to include the additional threat event information, and repeating the investigative operations subsequent to updating the known threat event information.

### BACKGROUND

Web-based platforms commonly employ security operations teams to investigate potential cyber threats to prevent or mitigate damage caused by malware attacks, data theft, and other malicious cyber acts. Although various automated tools exist to detect and flag potential suspicious events, it is common for these tools to generate large numbers of alerts that are, in turn, queued for further investigation. This further investigation entails mining different types of threat-specific information from various sources to construct a complete picture of the event that triggered the alert—e.g., users, devices, communications, files—and using this larger picture of the event to determine the degree of actual threat and extent of harm (if any) resulting from the event. These threat-specific investigations rely on repetitive yet complex processes that are difficult to scale. Although some aspects of these investigations can be automated, these tools still heavily rely on human investigators to drive the investigation by selecting which investigative paths to explore and/or the appropriate investigative actions to perform along each path.

It is typically time-prohibitive for a human operator to explore all possible investigation paths that may lead to the discovery of relevant information for a given investigation, even with the assistance of existing tools that partially automate these investigative operations. For this reason, security operations teams are forced to prioritize their investigative efforts on a small subset of the possible paths that could be explored. This leads to incomplete evidence collection, incomplete reporting, and incomplete corrective measures.

### SUMMARY

According to one implementation, a method for autonomously investigating a potential cyber security threat includes preparing and transmitting, to a language model, a set of inputs that includes known threat event information pertaining to the potential cyber security threat; a function list describing functions that execute different types of investigative operations; and instructions directing a language model to return an output identifying a next investigative action that the language model selects as appropriate to advance based on the known threat event information and the function list. The method further includes discovering additional threat event information by executing the next investigative action in response to receiving the output from the language model; updating the known threat event information to Classified as Microsoft Confidential include the additional threat event information; and repeating the method to autonomously identify and execute another instance of the next investigative action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example autonomous threat investigation system implementing the herein-disclosed technology.

FIG. 2 illustrates an example hierarchy of threat investigation agents within a threat investigation system deployed to investigate a cyber event that triggered a threat alert.

FIG. 3 illustrates aspects of yet another example threat investigation system that employs autonomous agents to autonomously investigate a threat alerts pertaining to suspicious cyber events.

FIG. 4 illustrates an example threat investigation system that includes a hierarchy of autonomous threat investigation agents implementing the herein-disclosed technology.

FIG. 5 illustrates example operations for conducting autonomous threat investigations.

FIG. 6 illustrates an example schematic of a processing device suitable for implementing aspects of the disclosed technology.

### DETAILED DESCRIPTION

Cloud service providers commonly employ automated security systems to detect and flag potential cyber security threats. As used herein, the term “potential cyber security threat” refers to any observable event within a system, network, or digital environment that may affect the security of information assets or information technology infrastructure. These events can range from routine system logs to unusual activities that may indicate a security issue. Examples of potential cyber security threats include anomalous activities such as unusual user login time, abnormal data transfers, and unexpected security behavior that may or may not represent an actual security risk. Potential cyber security threats also include confirmed activities that compromise the confidentiality, integrity, or availability of information, such as the detection of a malware infection, unauthorized access, or a data breach.

When a cloud service provider utilizes an automated security system to detect potential cyber security threats, the resulting alerts are typically routed to a security operations team tasked with investigating alerts and implementing remedial actions. Due to the tremendous volume of alerts that these systems tend to generate, it is common for investigators to follow up on only a tiny percentage of the alerts while performing no investigation at all for the vast majority of alerts received.

For the small percentage of alerts that are investigated, the breadth and quality of the investigation may be severely limited by the above-mentioned time constraints imposed on human operators. Investigators often follow tree-like best practice guidelines (“investigation trees”), with each node representing a different investigative action. A tree may sometimes have hundreds or thousands of paths to explore. Investigators must make difficult and often arbitrary decisions when selecting which paths to investigate.

The herein-disclosed technology includes an autonomous, AI-driven threat investigation system that deploys agents to perform investigative decision-making instead of the traditional human operator, leveraging a powerful semantic memory index and a language model to identify appropriate “next” steps within an investigation tree, identifying and automatically invoking (and in some cases, self-generating) appropriate software tools to perform each investigative step while exploring many (e.g., hundreds or thousands) of different paths of the investigation tree in parallel. Parallel path investigation is achieved, in part, by a novel isolation mechanism that provides for instantiating a tree-like structure of independent sub-agents that each store a different path-specific and node-specific investigation context in its working memory. When configured in this way, each agent performs decision-making based on a slightly different body of investigative evidence (e.g., the most relevant evidence to the corresponding sub-investigation). This technique prevents cross-path contamination of facts discovered along various branches of the investigation tree that may otherwise provoke language model hallucinations, leading to inaccurate or inconclusive threat diagnosis.

The above-described techniques make it possible to automate all or a vast majority of the decision-making that is presently delegated to human investigators while simultaneously improving the quality of individual threat investigations by enabling rapid, parallel-branch sub-investigations that each entail hundreds or thousands of investigative sub-operations, providing a higher-fidelity data about each threat than that which is possible using previously-existing investigative tools. This represents a significant advancement in the field of cyber investigation, facilitating more comprehensive investigation and reporting than was previously possible while also reducing the total time devoted (e.g., by human or machine) to each individual threat investigation.

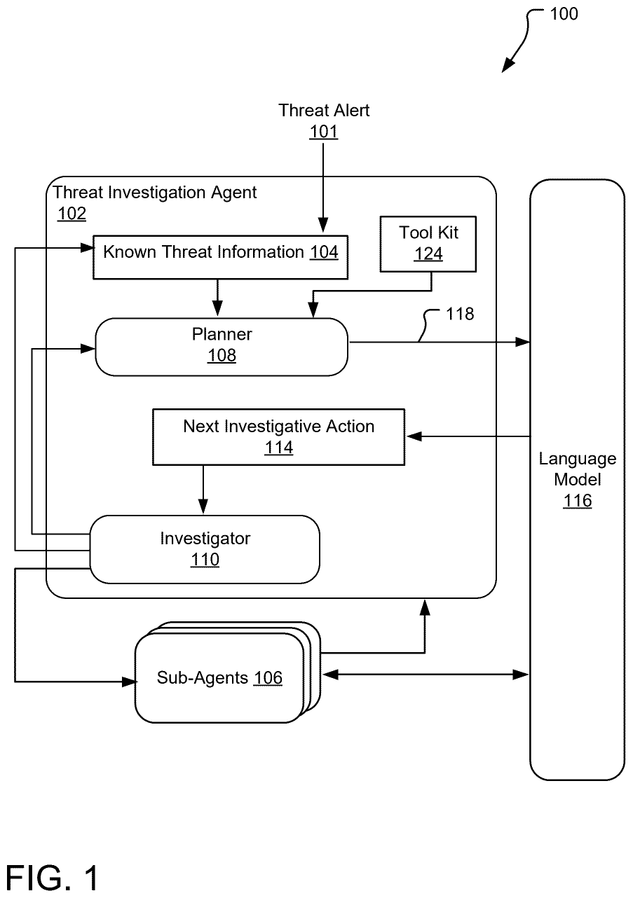

FIG. 1 illustrates an example autonomous threat investigation system 100 implementing the herein-disclosed technology. The autonomous threat investigation system 100 is tasked with investigating a threat alert 101 and includes multiple independent software agents (e.g., threat investigation agent 102 and sub-agents 106) that perform different, complimentary investigative operations. In one implementation, the autonomous threat investigation system 100 investigates a single threat alert at a time, and different instances of the autonomous threat investigation system 100 are instantiated to facilitate parallel investigations of different threat alerts.

The threat alert 101 is triggered by a suspicious cyber event observed within a network. In some implementations, the threat alert 101 is automatically generated, such as by a security tool that enforces rule-based detection logic. For example, a security rule may trigger the auto-generation of a threat alert whenever a user account is accessed from a new internet protocol (IP) address or whenever a system user receives an email with an attachment from an unrecognized sender. In other implementations, the threat alert 101 is manually triggered, such as by a user reporting a phishing email or other suspicious event to a security tool.

The threat alert 101 is received at a threat investigation agent 102, also referred to herein as the “root agent”—the agent that commences a new investigation. During the investigation pertaining to the threat alert 101, the root agent instantiates various sub-agents 106, each of which can instantiate further sub-agents, all of which are tasked with investigating different subsets of facts within a master fact pattern uncovered throughout the investigation. Upon concluding each respective portion of the larger investigation, each of the sub-agents 106 reports its findings back to its creator, e.g., the parent agent that instantiated the sub-agent.

In one implementation, the threat investigation agent 102 and the sub-agents 106 include identical executable logic. Different instances of the threat investigation agent 102 deployed within the same system (e.g., to investigate the same event) may store different versions of the known threat event information 104 (different fact patterns) in working memory, each version representing a subset of the larger fact pattern describing the event being investigated.

Upon receiving the threat alert 101, the threat investigation agent 102 commences the investigation by extracting known threat event information 104 from the threat alert 101 and storing this information in its local working memory. For example, the known threat event information 104 identifies an action, event, or communication that involved a pair of entities, with examples of entities including user identifier (IDs), internet protocol (IP) addresses, device IDs, and file IDs (e.g., a unique file hash). In some implementations, the threat alert 101 may additionally identify a type or classifier for the event that triggered the threat alert 101, such as “suspicious email,” “suspicious data exfiltration,” or “suspicious user sign-on.”

Within the threat investigation agent 102, two key software components—a planner 108 and an investigator 110—work together to iteratively drive an investigation cycle. The planner 108 uses the known threat event information 104 to inform the selection of a next investigative action 114, while the investigator 110 oversees execution of the next investigative action 114 and updates the known threat event information 104 to include newly-discovered threat event information. This newly discovered threat event information is, in turn, used by the planner 108 to inform the selection of the next investigative action 114. This flow repeats until the threat investigation agent 102 instantiates the sub-agents 106, which then begin independently driving parallel instances of this cycle to explore different paths in the investigation tree, as is further described below.

To determine the next investigative action 114, the planner 108 prepares inputs 118 (e.g., a prompt) for a language model 116. These inputs 118 include at least some investigation context data (e.g., the known threat event information 104), a description of investigative software tools available in a tool kit 124, and instructions that direct the language model 116 to use the tool kit 124 and the context data to identify a most appropriate next action to advance the investigation. In one implementation, the instructions further direct the language model 116 to respond with respond with information identifying how to execute the identified next appropriate next action in the investigation.

The language model 116 is a model trained to interpret textual inputs, including natural language processing (NLP) models as well as models that process textual-based code, and certain multimodal models that can receive prompts that include various types of input (e.g., text, image, audio, and/or video data) and likewise generate outputs of multiple types that are not necessarily the same as the input type. Examples of publicly available multimodal language models include the Mistral AI model and the large language model Meta AI (LLaMa) model. Further examples of language models include transformer-based models such as generative pre-trained transformer (GPT) models, Open Pretrained Transformer (OPT) models, and Bidirectional Encoder Representations from Transformers (BERT) models, as well as Bioscience Large Open-science Open-access Multilingual (BLOOM) models, seq2seq models, long short-term memory (LSTM) network, and recurrent neural networks (RNNs).

In response to receiving and processing the inputs 118, the language model 116 outputs the next investigative action 114, which identifies a specific action executable to acquire a target piece of new event information—e.g., a fact that expands on the fact pattern initially represented by the known threat event information 104. To generate the next investigative action 114, the language model 116 answers two separate but related questions: (1) What target piece of unknown information should be next sought to advance the investigation? and (2) Can the target piece of information be acquired with a tool within the tool kit 124?

In different implementations, the language model 116 answers the first of these two questions (e.g., what target information to seek next) in various ways. In a first implementation, the language model 116 is specially trained on a dataset that includes a large corpus of threat investigation data, such as threat investigation decision trees and fact-specific operations previously performed in association with different nodes of the decision trees. In this implementation, the language model 116 can identify the next investigative action 114 by comparing the investigation context data (e.g., the known threat event information 104) to fact patterns within its training corpus to infer the target piece of information that is to be acquired via the next investigative action 114.

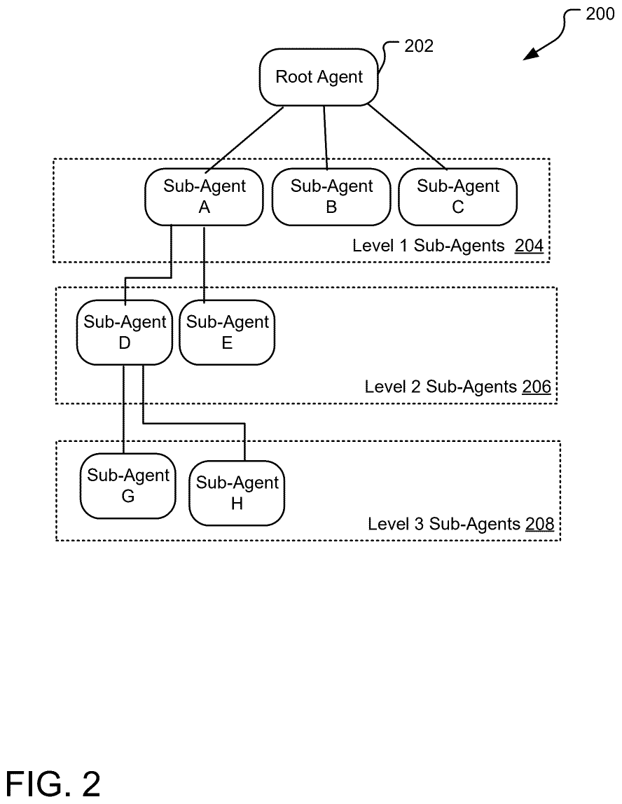

In a second implementation, the language model 16 is not specially trained on investigation guidance material but is instead a general-purpose (off-the-shelf) language model. In this case, the planner 108 accesses a database of threat investigation reference materials and appends relevant reference material to the context data included in the inputs 118. This implementation is discussed further with respect to FIG. 2.

By example, assume the language model 116 processes the inputs 118 and determines that the target piece of information is a geographical location of a source IP address for a suspicious communication. Before outputting the next investigative action 114, the language model 116 addresses the second question presented above—e.g., what is the best method of acquiring this target piece of information?

The language model 116 answers this second question based on the description of tools in the tool kit 124 passed to the language model 116 within the inputs 118. In one implementation, the tool kit 124 includes descriptions of a set of functions invokable to perform different investigative operations, including a description of the parameters that each function accepts and the different accepted parameter values. Examples of different types of investigative operations carried out by the functions in the tool kit 124 include, for example, querying a third-party data source to retrieve a target piece of information (e.g., to determine whether an internet protocol (IP) address is known to be associated with a high level of fraudulent activity); retrieving information from a database; using a web-based API to communicate with an endpoint that provides a desired functionality, computing a file hash and performing some operation on the file hash such as by comparing to an index of file hashes corresponding to recognized files, and more. Based on the instructions included in the inputs 118, the language model 116 evaluates the descriptions of functions in the tool kit 124 and determines whether the target piece of information can be acquired by executing a function within the tool kit 124. If so, the language model 116 outputs a call to that function, formatted with the correct parameters, such that the function call can be executed upon receipt (by the investigator 110) without reformatting or other further action. If, for example, the tool kit 124 defines an IP-to-Geo lookup function that translates an IP address to a geographic location, the language model 116 outputs a call to the function with an input parameter value set to equal the IP address that is being investigated in the present step of the investigation.

The investigator 110 is tasked with executing the next investigative action 114 output by the language model 116, updating the known threat event information 104 as the investigation progresses. If, for example, the next investigative action 114 includes a function call to a tool within the tool kit 124, the investigator 110 executes that function call to acquire new event information. The investigator 110 then updates the known threat event information 104 to include this newly-acquired event information, and the planner 108 then generates a new instance of the inputs 118 that direct the language model 116 to identify the next appropriate investigative action based on the updated event information. Upon receipt of a new instance of the “next investigative action 114,” the investigator 110 executes the action as generally described above and again updates the known threat event information 104 to include newly obtained threat event information.

In addition to the above, the investigator 110 is equipped with delegation logic (not shown) that conditionally instantiates new agents (the sub-agents 106) in response to determining that newly-acquired threat event information introduces the potential for multiple independent sub-branches of investigation. If, for example, the next investigative action 114 provides for determining user identifiers of all users that clicked a particular uniform resource locator (URL), executing this action may yield an array of user identifiers that each may be independently subjected to further investigative actions. In cases such as this, where execution of the next investigative action 114 returns an array of entity identifiers, the investigator 110 instantiates a different sub-agent (e.g., one of the sub-agents 106) to proceed with investigating each different entity in the multi-entity array. This is discussed in greater detail with respect to FIG. 2 below.

FIG. 2 illustrates an example hierarchy of threat investigation agents within a threat investigation system 200 deployed to investigate a cyber event that triggered a threat alert (as generally described with respect to FIG. 1). A root agent 202 receives the initial threat alert, extracts known threat event information from the threat alert, and populates its working memory with the known threat event information. The root agent 202 performs the operations generally described with respect to FIG. 1—e.g., using the known threat event information to select the appropriate next investigative action, executing the next investigative action to determine additional threat event information, and updating the known threat event information to include the additional threat event information.

All agents in the threat investigation system 200 include delegation logic that provides for conditionally instantiating new agents at specific “branching points” of the investigation. In one implementation, the agents are configured to determine that a branching point has been reached when the execution of a particular investigative action returns a multi-entity array. Each entity represented in the multi-entity array represents an independent branch that can be subject to further investigation without impacting similar investigations of the other entities in the multi-entity array.

If, for example, the root agent 202 parses a log to determine which devices on a network accessed a particular file, the parsing action may return multiple device IDs. In this scenario, the root agent determines that a branchpoint point has been reached and, in response, delegates exploration of the corresponding new investigation branches to different sub-agents. If, for example, the multi-entity array returns three entities (e.g., three device IDs), the root agent 202 instantiates each of sub-agents A, B, and C, each of which is to assume responsibility for furthering the investigation in relation to a corresponding one of the device IDs. When an agent (e.g., the root agent 202) instantiates sub-agents (e.g., Level 1 sub-agents 204, including sub-agents A, B, and C), the working memory of each sub-agent is populated with a slightly different subset of the known threat event information that the root agent has discovered. For example, the working memory of a sub-agent matches its parent except that the sub-agent is aware of exclusively one of multiple entities that the parent agent discovered in a previous investigative step that triggered instantiation of the sub-agent.

Thus, in the above example where the root agent 202 discovers device IDs of three devices on a network that accessed a file, the root agent 202 instantiates sub-agent A and populates the working memory of sub-agent A with a first one of the discovered device IDs in addition to all threat event information that was stored in the root agent 202 before execution of the last-performed investigative action. Here, sub-agent A has no knowledge of the second device ID or the third device IDs that accessed the same file of interest. Likewise, sub-agent B is instantiated with working memory storing the fact that the second device ID accessed the file of interest and all threat event information that was stored in the root agent 202 prior to execution of the last-performed investigative action. Sub-agent B has no knowledge of the first device ID or the third device IDs that accessed the same file of interest. In the same regard, sub-agent C is instantiated with a working memory storing the fact that the third device ID accessed the file of interest and all threat event information stored in the root agent 202 prior to execution of the last-performed investigative action. Sub-agent C has no knowledge of the first device ID or the second device ID.

The level 1 sub-agents 204 each continue to iteratively perform the operations described with respect to FIG. 1 based on the information stored in their respective working memories. This information is used to inform the language model's selection of the “next investigative action” along each of the three different paths now defined. The iterative investigative operations of the level 1 sub-agents may be performed in parallel, as doing so reduces total investigation time compared to existing technologies that require an operator to select and initiate sequential sub-investigations.

When a sub-agent completes its respective sub-investigation, the sub-agent reports its findings to its parent agent before self-terminating. By this reporting, the working memory of each terminated sub-agent is rolled up into its parent. In the example shown, sub-agents B and C complete their respective investigations without reaching a new branching point. The working memories of sub-agent B and sub-agent C are rolled up into and merged with the working memory of the root agent 202. Sub-agent A, however, reaches a new branching point. For example, sub-agent A executes a function to determine which users signed onto the device with the first device ID during a target period, and the function returns a multi-entity array storing two user IDs. This, in turn, triggers the generation of a branch point.

Consequently, sub-agent A instantiates two new sub-agents—e.g., sub-agents D and E (collectively “Level 2 sub-agents 206)—to each continue the investigation concerning a given one of the two newly identified user IDs. As before, the parent agent (sub-agent A) populates the working memory of each new subagent (sub-agent D and sub-agent E) with a slightly different subset of its own known threat event information. In this case, sub-agents D and E have working memories that are identical except for the fact that each is made aware of exclusively one of the user IDs returned via execution of the previous investigative action.

In the example shown, sub-agent E completes its sub-investigation without reaching a new branching point. The working memory of sub-agent E rolled up into and merged with the working memory of the parent agent, sub-agent A. Following this, sub-agent E self-terminates. Sub-agent D reaches an additional branching point and instantiates Level 3 sub-agents 208, sub-agents G and H. The working memories of sub-agents G and H are identical to that of the parent agent (sub-agent D), except that sub-agents G and H are each aware of exclusively one of two newly-discovered entity identifiers.

In the example shown, sub-agents G and H each complete their respective sub-investigations without reaching an additional branching point. The working memories of sub-agents G and H are rolled up into and merged with the working memory of their parent—sub-agent D—before sub-agents G and H autonomously terminate. Sub-agent D then passes its own working memory up to its parent agent, sub-agent A, where it is merged with the working memory already storing findings of sub-agents A and E, and sub-agent D self-terminates. Sub-agent A then passes its working memory up to the root agent 202 before self-terminating. When all sub-agents have terminated, the root agent 202 generates and outputs a final investigative report that incorporates relevant findings of all sub-agents.

The above-described use of a tree-like structure of independent sub-agents, each storing a different path-specific and node-specific investigation context in working memory, allows each agent to independently select and execute investigative actions based on a slightly different body of investigative evidence (e.g., the evidence that is most relevant to the corresponding sub-investigation). Since each agent uses its own working memory to populate context data passed to the language model, this multi-agent branching technique ensures that language model inputs are not diluted with information irrelevant to the sub-investigation assigned to the agent (e.g., information that could potentially impede the language model's ability to select the most appropriate investigative steps). Moreover, since the working memory of each agent is “rolled up” into its parent, as described above, a single comprehensive report can be generated from the many independent and parallel sub-investigations.

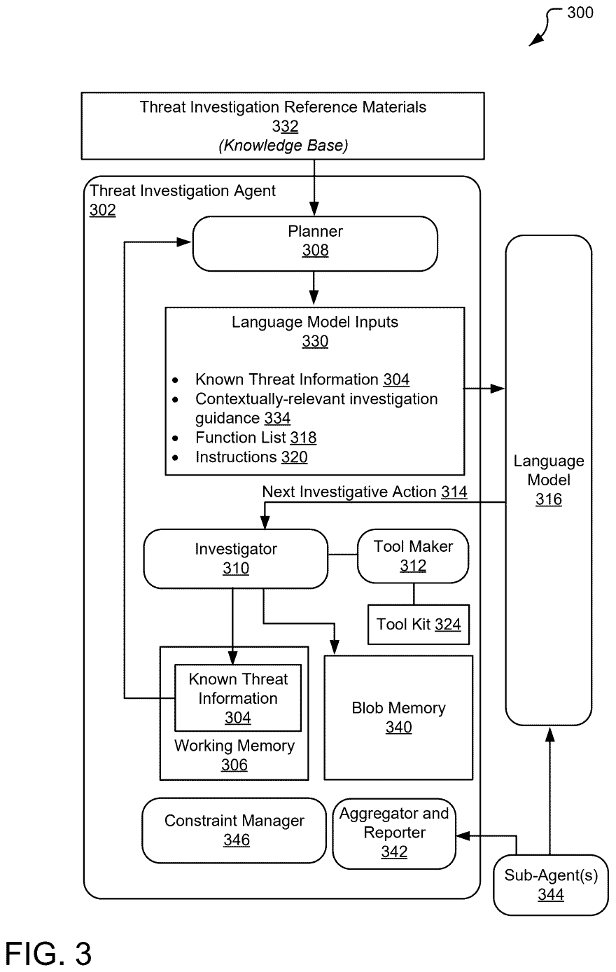

FIG. 3 illustrates aspects of another example threat investigation system 300, which employs autonomous agents to autonomously investigate threat alerts pertaining to suspicious cyber events. Similar to the system of FIG. 1, the threat investigation agent 302 includes a planner 308 that prepares language model inputs that facilitate selection of investigative actions (e.g., a next investigative action 314) to execute based on a body of known threat event information 304 that grows as the investigation progresses.

In the system of FIG. 3, the planner 308 has access to a knowledge base storing threat investigation reference materials 332. These threat investigation reference materials 332 include, for example, best practice guidelines and various investigation decision trees pertaining to different types of cyber security events. Prior to querying a language model 316 with language model inputs 330, the planner 308 performs a semantic retrieval operation to identify relevant context data from the threat investigation reference materials 332 that is to be included in the language model inputs 330 and used to inform the language model's selection of the next investigative action 314.

In one implementation, this semantic retrieval entails generating an event vector (not shown) that embeds the known threat event information 304. Different portions of the threat investigation reference materials 332 are likewise vectorized into reference material vectors (in a same vector space as the event vector), and a vector comparison is conducted to determine a degree of similarity between the event vector and each reference material vector. This comparison may, for example, entail computing a cosine similarity or a dot product to identify one or multiple of the reference material vectors that are most semantically similar to the event vector. The portion(s) of the threat investigation reference materials 332 identified as sharing a greatest semantic similarity with the event vector are then selected to serve as contextually-relevant investigation guidance 334, which is included in the language model inputs 330 that the planner 308 passes to the language model 316.

In addition to the contextually-relevant investigation guidance 334, the language model inputs 330 include the known threat event information 304 that was used to select the contextually-relevant investigation guidance, a function list 318, and a set of instructions 320.

The function list 318 includes function descriptors for a set of functions within a tool kit 324 invokable to perform different investigative operations. A function descriptor describes the functionality of a corresponding function in the tool kit 324 while also identifying the parameters that the function accepts as input and the corresponding selectable parameter values. This information is sufficient to allow the language model 316 to construct calls to the functions included in the tool kit 324.

The set of instructions 320 directs the language model 316 to use the contextually-relevant investigation guidance 334 and the known threat event information 304 to determine a next action in the investigation—e.g., a step for obtaining an identified target piece of information that is not yet known. The instructions 320 further direct the language model 316 to evaluate the function descriptors in the tool kit 324 in view of the determined “next action” and, if a suitable function is found in the tool kit 324, to return a function call executable to carry out the next investigative action. Thus, in scenarios where tool kit 324 includes a function executable to obtain the identified target piece of information, the next investigative action 314 includes a properly formatted function call with function parameter(s) identifying portion(s) of the known threat event information 304.

Notably, the threat investigation agent 302 further differs from that of FIG. 1 due to its inclusion of a tool maker 312 that is capable of making software tools to help carry out the next investigative action 314 in scenarios where the tool kit 324 does not already store a suitable function. Thus, in scenarios where the language model 316 is unable to identify an existing function suitable to obtain a target piece of information, the tool maker 312 may be invoked to create a software tool that provides a desired functionality.

To facilitate the above-described tool making, the instructions 320 may further include a directive instructing the language model 316 to output a description of the functionality needed to acquire the target piece of information in scenarios where a suitable function is not found in the tool kit 324. Assume, for example, that the language model 316 evaluates the language model inputs 330 and determines that the next investigative action is to query a database to determine timestamps corresponding to communications between two devices. If, in this scenario, the tool kit 324 does not include a tool providing this custom functionality, the language model 316 may respond with a directive that says (e.g., “the next action is to query [database name] to receive the timestamps of communications between [deviceID_1] and [Device_ID2],” (e.g., referencing relevant identifiers from the known threat event information 304). Thus, in scenarios such as the above where the next investigative action 314 does not include a function call to the tool kit 324 and instead describes a desired functionality, the tool maker 312 is instructed to automatically generate executable code that supplies the desired functionality.

The tool maker 312 includes a language model trained on a corpus of code that is capable of translating a natural language description of a functionality to executable code that provides that functionality. For example, the tool maker 312 can generate custom database calls or API calls to communicate with third-party services. Examples of executable code potentially generated by the tool maker 312 include scripts that are to be executed by a specific interpreter or scripting engine (e.g., a database script, JavaScript, Bash) or code that can be compiled into an executable file run by the operating system. Examples of publicly-available models capable of generating code based on natural language inputs include Microsoft Copilot, Codex, and StarCoder. Each new tool created by the tool maker 312 is added to the tool kit 324 such that it may be invoked (e.g., with different parameters) during future steps of the ongoing investigation.

Like the threat investigation agent of FIG. 1, the threat investigation agent 302 includes an investigator 310 that is tasked with carrying out each next investigative action 314 output by the language model 316. If, for example, the next investigative action 314 includes a function call to a tool within the tool kit 324, the investigator 310 executes that function call. Alternatively, if the next investigative action 314 describes the functionality of a new tool that does not yet exist in the tool kit 324, the investigator 310 delegates the construction of that function to the tool maker 312 and, once the tool is created, executes the function. In some implementations, executing the next investigative action 314 entails transmitting a follow-up instruction to the language model 316. For example, the investigator 310 may transmit an updated version of the tool kit 324 (identifying the newly-created tool) to the language model 316 along with a directive instructing the language model 316 to return a function call executable to obtain the target information. In response, the language model 316 outputs a function call to the newly-created tool that the investigator 310 can, in turn, execute to acquire the target information identified in the next investigative action 314.

Each time the investigator 310 discovers new threat event information by executing an instance of the next investigative action 314, investigator 310 updates the known threat event information 304 in working memory 306. Notably, threat investigation agent 302 of FIG. 3 also includes a blob memory 340 that is used to store intermediary information that is discovered by the threat investigation agent 302 as a precursor to obtaining new relevant threat information. Assume, for example, a tool from the tool kit 324 is used to retrieve a table from a third-party database and to extract relevant values from the table. In this case, the relevant values (the target information) are saved in the working memory 306, whereas the full table is stored in the blob memory 340 so that it may be quickly accessed again if the same type of investigative action is subsequently identified as appropriate (e.g., with respect to different items in the table) during the same investigation. When populating the language model inputs 230, the planner 308 pulls the known threat event information 304 from the working memory 306 but does not access the blob memory 340. Thus, the blob memory 340 can be used as a cache to reduce look-up times associated with repetitive actions without a risk of “polluting” the language model inputs 230 with information not directly relevant to the investigation that might provoke model hallucinations.

The investigator 310 includes delegation logic that provides for conditionally instantiating sub-agents 344 at certain branching points of the investigation, e.g., in a manner consistent with the methodology generally described with respect to FIG. 2, with each of the sub-agents 344 having identical executable components to the threat investigation agent 302. When a sub-agent concludes its sub-investigation (e.g., the language model 316 outputs information indicating it is unable to determine the next investigative action), the sub-agent transmits its working memory up to a reporting manager 342 of the sub-agent's parent agent. The reporting manager 342 merges the investigative data received from the sub-agent with the investigative data that is locally stored (e.g., in the working memory 306 of the parent agent) and generates a human-readable report that summarizes the findings of the parent agent and all sub-agents that reported back to the parent agent.

In addition to the elements described above, the threat investigation agent 302 further includes a constraint manager 346 that enforces a defined “investigation budget” for the threat investigation agent 302. When the defined budget is reached, the threat investigation agent 302 automatically terminates its investigation, reports its investigative findings to its parent agent (or generates a final report if the agent is the root agent), and self-terminates. The defined “budget” of the threat investigation agent 302 may, in various implementations, be set in terms of different metrics, such as in terms of total processing time, memory utilization, number of language model calls placed, number of tokens processed by the language model 316, number of tools invoked or called, max number of database queries, or any other suitable metric.

The investigation budget serves as a safeguard to ensure that it is not possible for the threat investigation agent 302 to get caught in a logical loop that hangs indefinitely, such as a result of model hallucinations or any other cause. Additionally, the enforcement of the investigation budget by the constraint manager 346 facilitates agent-level of control over resource waste in an otherwise fully autonomous system. In one implementation, the size of the investigation budget is predefined within a given agent based on one or more investigation-specific policies, such as a determined relative severity of the threat alert type and/or a priority level assigned to a specific sub-investigation that the threat investigation agent 302 is conducting. In one implementation, the constraint manager 346 selects and enforces the investigation budget based on predefined policies, such as policies triggered by the type of alert received (e.g., data exfiltration alert, suspicious sign-on, suspicious email) with larger budgets being automatically set for investigations pertaining to alert types that are classified as more serious and smaller budgets being automatically set for investigations that are less serious. In one implementation, a total investigation budget is allocated to the root agent, such as by default or based on the type of alert being investigated, and each sub-agent instantiated by the root agent is automatically allocated a fraction of the total investigation budget with the fraction being set based on default or based on facts specific to the sub-investigation that the agent is to be conducting. By using policies to set agent-level budgets for individual sub-investigations, different types of sub-investigations can be allocated greater or lesser budgets that correlate with the likely priority/importance of the sub-investigation in view of the investigation as a whole.

In one implementation, the constraint manager 346 enforces rules that serve to mitigate or slow the rate of resource usage (e.g., prior to self-terminating) upon determining that a budget cap is approaching. For example, the constraint manager 346 may enforce a policy that prohibits use of certain “expensive” tools in tool kit 324 (e.g., tools that utilize significant processing power) when a budget cap is approaching.

Although forced self-termination may prevent some investigations from autonomously reaching a final disposition, this practice facilitates responsible resource usage while drastically reducing the typical workload of security operations teams. When a threat investigation system terminates early due to reaching an investigation budget cap, the system-generated report can be passed to a human investigator to determine how to proceed—e.g., to perform follow-up investigative actions as necessary to conclude the investigation in a satisfactory manner. Even in these early termination scenarios, the quantity of autonomously collected investigation data drastically reduces the total time to final disposition, saving the human investigator 70% or more of the total time that would otherwise be devoted to investigating the threat.

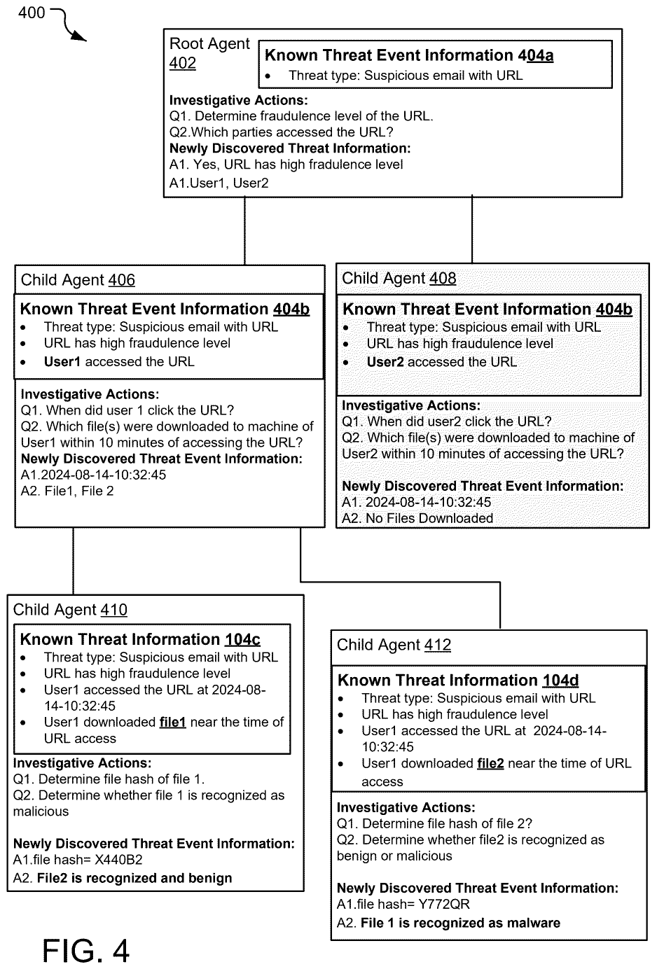

FIG. 4 illustrates a flow of example investigative actions performed by various threat investigation agents 400 implementing the herein-disclosed technology to investigate a threat alert triggered by a suspicious cyber event. A root agent 402 receives the threat alert and populates its working memory with known threat event information 404a. In the example shown, the known threat event information 104a initially includes a threat type identifier: “suspicious email with URL.” Although not shown for brevity, the known threat event information 404a may also include specific indicators (entities) extracted from the initial alert, such as the sender and recipients of the email, the source and destination IP addresses, and the URL that is included. The root agent 402 begins conducting investigative operations (e.g., the iterative cycle generally described with respect to FIG. 1 or FIG. 3) and executes a tool to assess the fraudulence level known to be associated with the URL. Based on the execution of this investigative action, the root agent 402 determines that the URL is known to be associated with a high fraudulence level. This fact is appended to the known threat event information 404a, and the root agent 402 determines that the next appropriate action is to determine which users within an organization accessed the URL. The root agent 402 executes this action (e.g., by invoking a suitable tool and/or making such tool if not already available), and identifies two users—User1, User2—within the organization that clicked on the URL. This information is also added to the working memory of the root agent 402.

The discovery of this multi-entity array (User1, User2) triggers branching logic that causes the root agent 402 to instantiate a first child agent 406 and a second child agent 408. The working memories of the first child agent 406 and the second child agent 408 are populated with different subsets of the threat event information that is now present within the working memory of the root agent 40. Specifically, the working memory of the first child agent 406 identifies the following facts: (1) the threat type is a suspicious email that includes a URL; (2) the URL has a high fraudulence level; and (3) User1 accessed the URL. The working memory of the second child agent 408 identifies the first of these two facts, but differs by storing the fact that User2 accessed the URL (rather than User1).

The first child agent 406 and the second child agent 408 begin conducting their branch-specific sub-investigations. The first child agent 406 executes two more investigative actions to determine (1) when did User1 click the URL? and (2) which files were downloaded to User1's machine within 10 minutes of accessing the URL? By executing calls to appropriate tools to perform these actions, the first child agent 406 retrieves a timestamp for User1's URL access and identifies two files—file1, file2—that were downloaded to User1's machine within 10 minutes of the timestamp. The discovery of this multi-entity array (file1, file2) again triggers the branching logic. Consequently, the first child agent 406 instantiates two more child agents—a third child agent 410 and a fourth child agent 412.

Meanwhile, in a parallel investigation, the second child agent 408 performs investigative actions similar to the first child agent 406. In the example shown, the second child agent 408 seeks out and retrieves a timestamp for User2's URL access but then determines that User2 did not download any files within 10 of the timestamp. Following this, the second child agent 408 determines that there are no further appropriate investigative actions (e.g. when the language model is unable to identify a suitable next action). Consequently, the second child agent 408 reports its findings to the root agent 402 and self-terminates.

After receiving and storing the investigative finding from the second child agent 408, the root agent 402 remains in a “wait” mode, pending results of sub-investigations along the branches originating at the first child agent 406. When initially instantiated, the working memories of the third child agent 410 and the fourth child agent 412 are populated with different subsets of the threat event information known to the parent, the first child agent 406. Specifically, the working memory of the third child agent 410 identifies the following facts: (1) the threat type is a suspicious email including a URL; (2) the URL has a high fraudulence level; (3) User1 accessed the URL at timestamp=2024-08-14-10:32:45; and User1 downloaded file1 within 10 minutes of accessing the URL. The working memory of the second child agent 408 likewise identifies (1)-(3) but alters in that it stores the fact that User1 downloaded file2 near the time of URL access (rather than file1).

The third child agent 410 identifies and executes further investigative actions to determine (1) what is the file hash of file1? and (2) is the file hash is recognized as malicious? In response to invoking identified suitable tools, the third child agent 410 obtains the file hash and determines (e.g., by comparing the file hash to an index of known malicious files) that the file is not recognized as malicious. The third child agent 410 is then unable to identify further appropriate investigative actions, consequently, it reports its findings to the first child agent 406 and self-terminates.

Meanwhile, the fourth child agent 412 performs a similar, parallel sub-investigation with respect to file2. In this case, however, the fourth child agent 412 determines that file2 is a recognized malicious file (type=malware). The fourth child agent 412 determines that there are no further appropriate investigative actions (e.g., when the language model is unable to identify a suitable next action). Consequently, the fourth child agent 412 reports its findings to the first child agent 406 and self-terminates. In response to receiving the investigative data from all of its sub-agents and merging this data with its own investigative findings, the first child agent 406 reports the merged information back to the root agent 402. The root agent 402 generates a final report that summarizes the threat event information identified by all system agents.

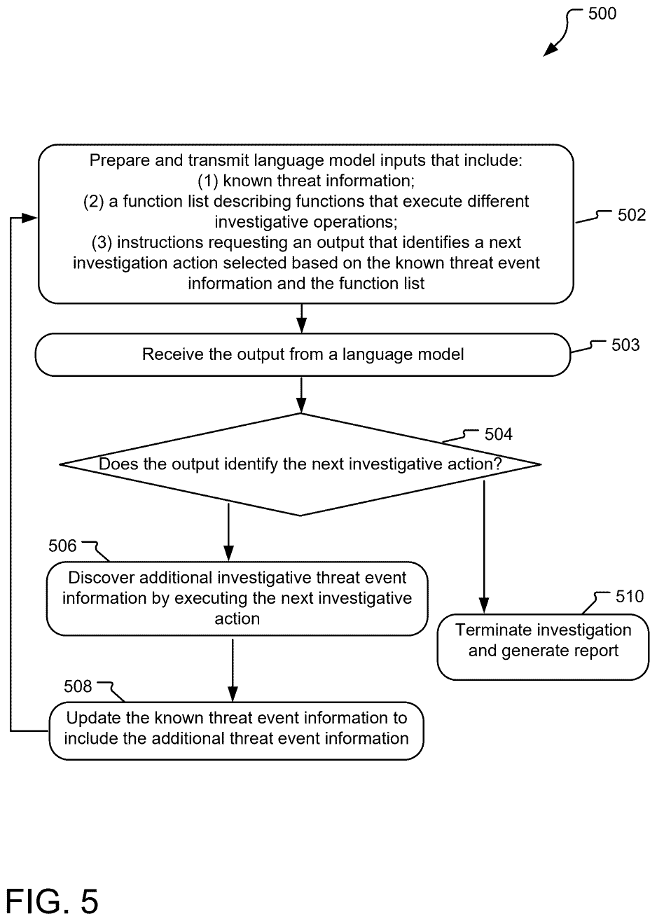

FIG. 5 illustrates example operations 500 for conducting fully autonomous threat investigations. In one implementation, the operations 500 are implemented by a threat investigation agent that performs some or all functionality described with respect to FIG. 1-4. An input preparation operation 502 prepares inputs for a language model. In one implementation, the inputs include a prompt that passes the language model known threat event information pertaining to a web-based security alert, a function list describing functions that execute different investigative actions, and instructions that direct the language model to output information identifying a most appropriate next investigative action that is selected based on the known threat event information and tools available within the function list.

In some implementations, the instructions direct the language model to respond with a function call to a function selected from the function list identified as suitable for carrying out the next investigative action or, if no suitable function can be identified, to respond with a description of a desired functionality that references identifiers included within the known threat event information. Additionally, the instructions may, in some implementations, provide a conditional directive that the language model is to follow if appropriate further investigative actions cannot be identified. For example, the language model may, in such case, be directed to respond with an “investigation complete” response or a function call to a reporting function that, upon execution, triggers reporting and self-termination of the agent.

A determination operation 504 determines whether the output received from the language model identifies a next investigative action. If not, a termination and report generation operation 510 terminates the investigation and generates a report that summarizes the known threat event information.

In instances where the determination operation 504 determines that the language model output does identify a next executable action, the operations proceed to an action execution operation 506, which executes the next investigative action to discover additional threat event information. In some implementations, the action execution operation 506 entails executing a function call that is output by the language model. In other implementations, the action execution operation 506 entails passing a description of a desired functionality (e.g., output by the language model) to a tool-making model trained to generate executable code that performs functions described by semantic inputs. The tool-making model generates a suitable executable tool that provides the desired functionality, and the tool is then executed to discover the additional threat event information. Additionally, the tool is then added to a tool kit (e.g., a list of available functions) to be re-used in subsequent investigative operations.

Following discovery of the additional threat event information, an update operation 508 updates the known threat event information to include the additional threat event information, and the input preparation operation 502 re-executes, passing the updated threat information to the language model and requesting identification of a next appropriate investigation action. The operations 502, 504, 506, and 508 repeat cyclically until the language model produces an output indicating that an appropriate next investigative action could not be identified, triggering the termination and report generation operation 510.

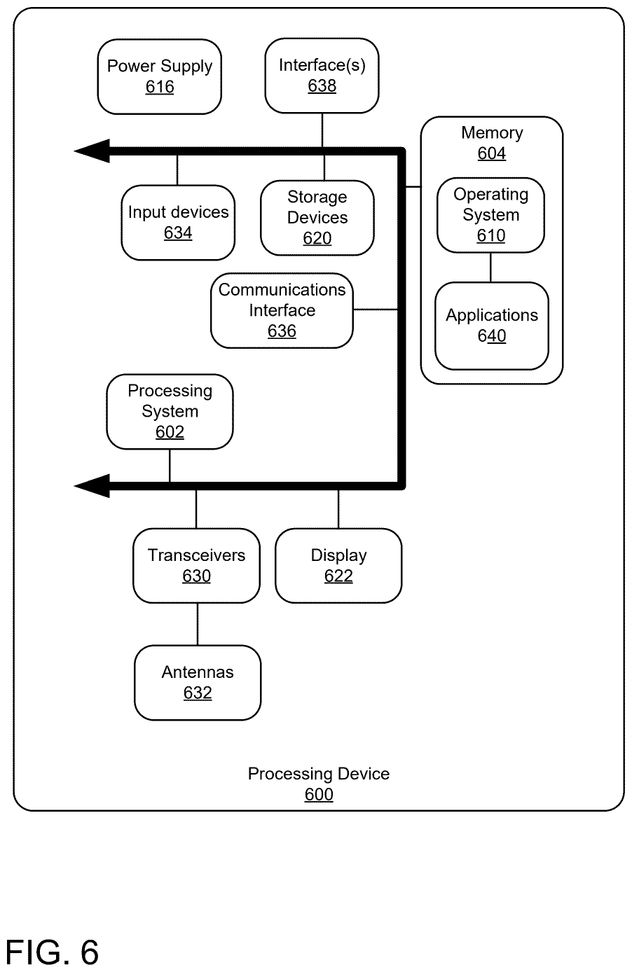

FIG. 6 illustrates an example computing device 600 for use in implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more hardware processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more software modules, segments, and/or processors, such as applications 650 (e.g., the threat investigation agent 102) are loaded into the operating system 610 on the memory 604 and/or the storage 620 and executed by the processor(s) 602. The storage 620 may store known threat event information included in an automatically-generated threat alert, threat event information discovered by an autonomous agent during an on-going investigation, and threat investigation reference materials used to inform the selection of investigative actions.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices) that is used to establish connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In some aspects, the techniques described herein relate to a threat investigation system including: a threat investigation agent stored in memory that performs investigative operations to investigate to a potential cyber security threat, the investigative operations including: preparing and transmitting language model inputs that includes: known threat event information pertaining to the potential cyber security threat; a function list describing functions that execute different types of investigative operations; and instructions directing a language model to return an output identifying a next investigative action that the language model selects as appropriate based on the known threat event information and the function list; discovering additional threat event information by executing the next investigative action in response to receiving the output from the language model; updating the known threat event information to include the additional threat event information; and repeating the investigative operations subsequent to updating the known threat event information.

In some aspects, the techniques described herein relate to a threat investigation agent, wherein preparing the language model inputs further include: generating an event vector encoding the known threat event information; and extracting contextually-relevant investigation guidance from a database by comparing the event vector to vectorized representations of portions of threat investigation reference materials, wherein the instructions direct the language model to use the contextually-relevant investigation guidance and the known threat event information to determine the next investigative action.

In some aspects, the techniques described herein relate to a threat investigation agent, wherein the output from the language model includes a function call to a function described within function list, the function call including a parameter identifying at least a portion of the known threat event information.

In some aspects, the techniques described herein relate to a threat investigation agent, wherein the instructions included in the language model inputs further instruct the language model to output a description of a software tool capable of performing the next investigative action in response to determining that the function list does not describe an appropriate tool invokable to execute the next investigative action.

In some aspects, the techniques described herein relate to a threat investigation agent, further including: a tool maker trained on a corpus of executable code and corresponding descriptions of code functionality, the tool maker being configured to receive the description of the software tool and autonomously generate a software tool executable to carry out the next investigative action, wherein the threat investigation agent executes the software tool generated by the tool maker to discover the additional threat event information.

In some aspects, the techniques described herein relate to a threat investigation agent, wherein the threat investigation agent includes branching logic that provides for conditionally instantiating multiple sub-agents in response to determining that the additional threat event information includes a multi-entity array, wherein different sub-agents of the multiple sub-agents store different subsets of the known threat event information in working memory and iteratively perform the investigative operations based on the different subsets of the known threat event information.

In some aspects, the techniques described herein relate to a threat investigation agent, wherein the threat investigation agent is configured to instantiate a sub-agent that: iteratively executes the investigative operations based on a version of the known threat event information that is stored in working memory of the sub-agent; and self-terminates and reports investigative findings back to the threat investigation agent in response to receiving an output from the language model indicating that the next investigative action could not be identified.

In some aspects, the techniques described herein relate to a method for autonomously investigating a potential cyber security threat, the method including: preparing and transmitting language model inputs that includes: known threat event information pertaining to the potential cyber security threat; a function list describing functions that execute different types of investigative operations; and instructions directing a language model to return an output identifying a next investigative action that the language model selects as appropriate to advance based on the known threat event information and the function list; discovering additional threat event information by executing the next investigative action in response to receiving the output from the language model; updating the known threat event information to include the additional threat event information; and subsequent to and based on the updating of the known threat event information, repeating the method to autonomously identify and execute another instance of the next investigative action.

In some aspects, the techniques described herein relate to a method, further including: generating an event vector encoding the known threat event information; and extracting contextually-relevant investigation guidance from a database by comparing the event vector to vectorized representations of portions of threat investigation reference materials, wherein the instructions direct the language model to use the contextually-relevant investigation guidance and the known threat event information to determine the next investigative action.

In some aspects, the techniques described herein relate to a method, wherein the output from the language model includes a function call to a function described within the function list, the function call including a parameter identifying at least a portion of the known threat event information.

In some aspects, the techniques described herein relate to a method, wherein the instructions further instruct the language model to output a description of a software tool capable of performing the next investigative action in response to determining that the function list does not describe an appropriate tool invokable to execute the next investigative action.

In some aspects, the techniques described herein relate to a method, further including: providing the description of the software tool capable of performing the next investigative action to a tool maker trained on a corpus of executable code and corresponding descriptions of code functionality, the tool maker being configured to receive the description of the software tool and autonomously generate a software tool executable to carry out the next investigative action; receiving the software tool from the tool maker; and executing the software tool to discover the additional threat event information.

In some aspects, the techniques described herein relate to a method, further including: conditionally instantiating multiple sub-agents in response to determining that the additional threat event information includes a multi-entity array, wherein different sub-agents of the multiple sub-agents store different subsets of the known threat event information in working memory and iteratively perform the investigative operations based on the different subsets of the known threat event information.

In some aspects, the techniques described herein relate to a method, wherein the multiple sub-agents are individually configured to self-terminate and generate a report summarizing investigative findings in response to receiving an output from the language model indicating that the next investigative action could not be identified.

In some aspects, the techniques described herein relate to a tangible processor-readable storage media encoding instructions for executing a process for autonomously investigating a potential cyber security threat, the process including: generating an event vector encoding known threat event information pertaining to the potential cyber security threat; extracting contextually-relevant investigation guidance from a database based on a comparison between the event vector and vectorized representations of portions of threat investigation reference materials; preparing and transmitting language model inputs that include: the known threat event information; the contextually-relevant investigation guidance; a function list describing functions that execute different types of investigative operations; and instructions directing a language model to return an output identifying a next investigative action is selected as appropriate to advance based on the known threat event information, the contextually-relevant investigation guidance, and the function list; discovering additional threat event information by executing the next investigative action in response to receiving the output from the language model; updating the known threat event information to include the additional threat event information; and subsequent to and based on updating of the known threat event information, repeating the process to autonomously identify and execute another instance of the next investigative action.

In some aspects, the techniques described herein relate to a tangible processor-readable storage media, wherein the output from the language model includes a function call to a function described within the function list, the function call including a parameter identifying at least a portion of the known threat event information.

In some aspects, the techniques described herein relate to a tangible processor-readable storage media, wherein the instructions further instruct the language model to output a description of a software tool capable of performing the next investigative action in response to determining that the function list does not describe an appropriate tool invokable to execute the next investigative action.

In some aspects, the techniques described herein relate to a tangible processor-readable storage media, wherein the process further includes: providing the description of the software tool to a tool maker trained on a corpus of executable code and corresponding descriptions of code functionality, the tool maker being configured to receive the description of the software tool and autonomously generate a software tool executable to carry out the next investigative action; receiving the software tool from the tool maker; and executing the software tool to discover the additional threat event information.

In some aspects, the techniques described herein relate to a tangible processor-readable storage media, further including: conditionally instantiating multiple sub-agents in response to determining that the additional threat event information includes a multi-entity array, wherein different sub-agents of the multiple sub-agents store different subsets of the known threat event information in working memory and iteratively perform the investigative operations based on the different subsets of the known threat event information.

In some aspects, the techniques described herein relate to a tangible processor-readable storage media, wherein the multiple sub-agents are individually configured to self-terminate and generate a report summarizing investigative findings in response to receiving an output from the language model indicating that the next investigative action could not be identified. The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A threat investigation system comprising:
a threat investigation agent stored in memory that performs investigative operations to investigate to a potential cyber security threat, the investigative operations comprising:
preparing and transmitting language model inputs that include:
known threat event information pertaining to the potential cyber security threat;
a function list describing functions that execute different types of investigative operations; and
instructions directing a language model to return an output identifying a next investigative action that the language model selects as appropriate based on the known threat event information and the function list;
discovering additional threat event information by executing the next investigative action in response to receiving the output from the language model;
updating the known threat event information to include the additional threat event information; and
repeating the investigative operations subsequent to updating the known threat event information.

2. The threat investigation agent of claim 1, wherein preparing the language model inputs further comprise:
generating an event vector encoding the known threat event information; and
extracting contextually-relevant investigation guidance from a database by comparing the event vector to vectorized representations of portions of threat investigation reference materials, wherein the instructions direct the language model to use the contextually-relevant investigation guidance and the known threat event information to determine the next investigative action.

3. The threat investigation agent of claim 1, wherein the output from the language model includes a function call to a function described within function list, the function call including a parameter identifying at least a portion of the known threat event information.

4. The threat investigation agent of claim 1, wherein the instructions included in the language model inputs further instruct the language model to output a description of a software tool capable of performing the next investigative action in response to determining that the function list does not describe an appropriate tool invokable to execute the next investigative action.

5. The threat investigation agent of claim 4, further comprising:
a tool maker trained on a corpus of executable code and corresponding descriptions of code functionality, the tool maker being configured to receive the description of the software tool and autonomously generate a software tool executable to carry out the next investigative action,
wherein the threat investigation agent executes the software tool generated by the tool maker to discover the additional threat event information.

6. The threat investigation agent of claim 1, wherein the threat investigation agent includes branching logic that provides for conditionally instantiating multiple sub-agents in response to determining that the additional threat event information includes a multi-entity array, wherein different sub-agents of the multiple sub-agents store different subsets of the known threat event information in working memory and iteratively perform the investigative operations based on the different subsets of the known threat event information.

7. The threat investigation agent of claim 1, wherein the threat investigation agent is configured to instantiate a sub-agent that:
iteratively executes the investigative operations based on a version of the known threat event information that is stored in working memory of the sub-agent; and
self-terminates and reports investigative findings back to the threat investigation agent in response to receiving an output from the language model indicating that the next investigative action could not be identified.

8. A method for autonomously investigating a potential cyber security threat, the method comprising:
preparing and transmitting a language model prompt that includes:
known threat event information pertaining to the potential cyber security threat;
a function list describing functions that execute different types of investigative operations; and
instructions directing a language model to return a first output identifying a next investigative action that the language model selects as appropriate to advance based on the known threat event information and the function list;
discovering additional threat event information by executing the next investigative action;
updating the known threat event information to include the additional threat event information; and
subsequent to and based on the updating of the known threat event information, repeating the method to instruct the language model to identify another instance of the next investigative action; and
generating and transmitting a report summarizing investigative findings in response to receiving a second output indicating that the next investigative action could not be identified by the language model.

9. The method of claim 8, further comprising:
generating an event vector encoding the known threat event information; and
extracting contextually-relevant investigation guidance from a database by comparing the event vector to vectorized representations of portions of threat investigation reference materials, wherein the instructions direct the language model to use the contextually-relevant investigation guidance and the known threat event information to determine the next investigative action.

10. The method of claim 8, wherein the first output from the language model includes a function call to a function described within the function list, the function call including a parameter identifying at least a portion of the known threat event information.

11. The method of claim 8, wherein the instructions further instruct the language model to first output a description of a software tool capable of performing the next investigative action in response to determining that the function list does not describe an appropriate tool invokable to execute the next investigative action.

12. The method of claim 11, further comprising:
providing the description of the software tool capable of performing the next investigative action to a tool maker trained on a corpus of executable code and corresponding descriptions of code functionality, the tool maker being configured to receive the description of the software tool and autonomously generate a software tool executable to carry out the next investigative action;
receiving the software tool from the tool maker; and
executing the software tool to discover the additional threat event information.

13. The method of claim 8, further comprising:
conditionally instantiating multiple sub-agents in response to determining that the additional threat event information includes a multi-entity array, wherein different sub-agents of the multiple sub-agents store different subsets of the known threat event information in working memory and iteratively perform the investigative operations based on the different subsets of the known threat event information.

14. The method of claim 13, wherein the multiple sub-agents are individually configured to self-terminate and generate a report summarizing investigative findings in response to receiving the second output from the language model indicating that the next investigative action could not be identified.

15. A tangible processor-readable storage media encoding instructions for executing a process for autonomously investigating a potential cyber security threat, the process comprising:
generating an event vector encoding known threat event information pertaining to the potential cyber security threat;
extracting contextually-relevant investigation guidance from a database based on a comparison between the event vector and vectorized representations of portions of threat investigation reference materials;
preparing and transmitting language model inputs that include:
the known threat event information;
the contextually-relevant investigation guidance;
a function list describing functions that execute different types of investigative operations; and
instructions directing a language model to return an output identifying a next investigative action is selected as appropriate to advance based on the known threat event information, the contextually-relevant investigation guidance, and the function list;
discovering additional threat event information by executing the next investigative action in response to receiving the output from the language model;
updating the known threat event information to include the additional threat event information; and
subsequent to and based on updating of the known threat event information, repeating the process to autonomously identify and execute another instance of the next investigative action.

16. The tangible processor-readable storage media of claim 15, wherein the output from the language model includes a function call to a function described within the function list, the function call including a parameter identifying at least a portion of the known threat event information.

17. The tangible processor-readable storage media of claim 15, wherein the instructions further instruct the language model to output a description of a software tool capable of performing the next investigative action in response to determining that the function list does not describe an appropriate tool invokable to execute the next investigative action.

18. The tangible processor-readable storage media of claim 17, wherein the process further comprises:
providing the description of the software tool to a tool maker trained on a corpus of executable code and corresponding descriptions of code functionality, the tool maker being configured to receive the description of the software tool and autonomously generate a software tool executable to carry out the next investigative action;
receiving the software tool from the tool maker; and
executing the software tool to discover the additional threat event information.

19. The tangible processor-readable storage media of claim 15, further comprising:
conditionally instantiating multiple sub-agents in response to determining that the additional threat event information includes a multi-entity array, wherein different sub-agents of the multiple sub-agents store different subsets of the known threat event information in working memory and iteratively perform the investigative operations based on the different subsets of the known threat event information.

20. The tangible processor-readable storage media of claim 19, wherein the multiple sub-agents are individually configured to self-terminate and generate a report summarizing investigative findings in response to receiving an output from the language model indicating that the next investigative action could not be identified.
